(19) United States
(12) Patent Application Publication
(10) Pub. No.: US 2026/0050825 A1
(43) Pub. Date: Feb. 19, 2026

(54) SYSTEMS AND METHODS FOR MONITORING AND MITIGATING OUTPUT VARIANCE BETWEEN BATCH-BASED AND REAL-TIME RESOURCE PROCESSING SYSTEMS

(71) Applicant: Capital One Services, LLC, McLean, VA (US)

(72) Inventors: Michael GARNER, Carrollton, TX (US); Landon M. NEHMER, McKinney, TX (US); Buvana SIVAKUMAR, Frisco, TX (US); Shailendra MAKTEDAR, McLean, VA (US); Russell DANNA, Rockwall, TX (US)

(73) Assignee: Capital One Services, LLC, McLean, VA (US)

(21) Appl. No.: 18/807,851

(22) Filed: Aug. 16, 2024

(51) Int. Cl. G06N 20/00

(52) U.S. Cl. CPC G06N 20/00

(57) ABSTRACT

Systems and methods for using a machine learning model for alignment with a rule set. In some aspects, the system receives a training dataset. The system trains a machine learning model based on the training dataset. The system processes, using a real-time resource processing system, a first resource access request, a first initial account state, and a first subsequent account state from a real-time data stream and generates a first approval determination. The system applies the machine learning model to the real-time data stream to generate a first confidence score that the new resource access request was executed correctly. Based on the first confidence score, the system determines that there is a discrepancy between the first approval determination by the real-time resource processing system and an expected approval of the machine learning model. Based on the discrepancy and a runtime explainability vector, the system adjusts the real-time resource processing system.

### SUMMARY

Methods and systems are described herein for novel uses and/or improvements to artificial intelligence applications. As one example, methods and systems are described herein for using a machine learning model to guide a real-time resource access approval system to adhere to a rule set corresponding to a batch-based resource processing system. For example, the system may receive a training dataset from a rule set-based batch processing system, the training dataset including resource access requests, first account states, second account states, and approval determinations. For example, the batch processing system may be a legacy system that processes resource access requests using rule sets. The batch processing system may be succeeded by a real-time resource processing system. The system may train a machine learning model using the training dataset to correlate access requests with likely approval determinations based on corresponding changes from a first account state to a second account state caused by the access request. This intervening machine learning model may be representative of expected output from the batch-based resource processing system. When the system uses a real-time system to generate approval decisions for resource access requests, the system may use the machine learning model to process the resource access request and associated account states to generate a probability that the request was processed correctly by the real-time system, i.e., the request was processed in a manner consistent with the legacy batch-based resource processing system. For example, the machine learning model may output a low probability indicating that the real-time system has diverged from an expected approval decision. In such cases, the system may adjust the set of logical operations of the real-time resource processing system using a runtime explainability vector from the machine learning model. By doing so, the system may leverage the intervening machine learning model to synchronize output of the batch-based resource processing system and the real-time resource processing system.

Conventional systems have not contemplated using a machine learning model, for example a deep learning model, to capture the logic of a rule set-based system and then use the machine learning model to guide a real-time system to replace the rule set-based batch processing system. Instead, conventional systems often need to start over, building the real-time system without leveraging the insight developed in the batch-based system due to data format differences, the inherent inability to train a real-time system directly using machine learning techniques, or other factors. Systems and methods described herein address this problem and allow the logic of the batch processing system to inform the decisions of the real-time processing system by training a machine learning model and using it as a guardrail for approval decisions of the real-time system. This has the advantage of preserving the logic of the batch-based system while processing the transaction correctness in real-time, creating more efficiency while maintaining accuracy.

In some aspects, methods and systems are described herein comprising: receiving a training dataset comprising a plurality of sample resource access requests, a plurality of sample first account states, a plurality of sample second account states, and a plurality of approval determinations, wherein each approval determination in the plurality of approval determinations corresponds to one or more resource access requests in the plurality of sample resource access requests; training a machine learning model based on the training dataset, wherein the machine learning model processes a resource access request, an input initial account state, an input subsequent account state, and an approval determination to generate a confidence score that the resource access request was executed correctly; processing, using a real-time resource processing system, a first resource access request, a first initial account state, and a first subsequent account state from a real-time data stream and generating a first approval determination, wherein the real-time resource processing system determines to approve or decline resource access requests based on a set of logical operations; applying the machine learning model to the real-time data stream to process the first resource access request, the first initial account state, the first subsequent account state, and the first approval determination and generating a first confidence score that the new resource access request was executed correctly; extracting a runtime explainability vector from the processing of the real-time data stream by the machine learning model; based on the first confidence score not exceeding a numeric threshold corresponding to the first approval determination, determining that there is a discrepancy between the first approval determination by the real-time resource processing system and an expected approval determination based on the machine learning model; and based on the discrepancy and the runtime explainability vector, adjusting the set of logical operations of the real-time resource processing system.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for using machine learning models to create adherence to rule sets, in accordance with one or more embodiments.

FIG. 2 shows an illustration of a process by which a batch-based resource processing system's logic is used to guide a real-time resource processing system, in accordance with one or more embodiments.

FIG. 3 shows illustrative components for a system for using machine learning models to create adherence to rule sets, in accordance with one or more embodiments.

FIG. 4 shows a flowchart of the steps involved in using machine learning models to create adherence to rule sets, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

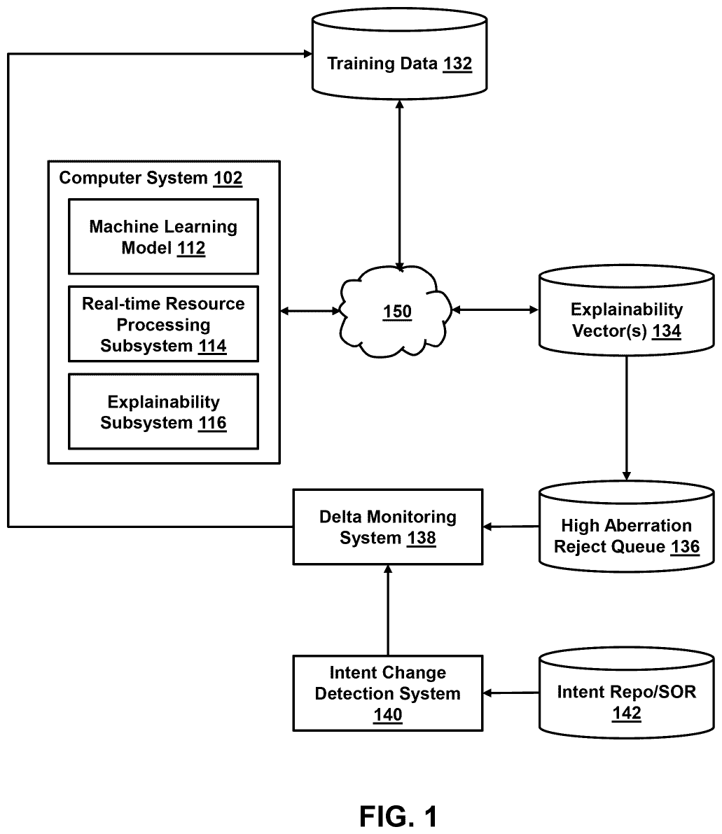

FIG. 1 shows an illustrative diagram for system 150, which contains hardware and software components used to train machine learning models, extract explainability vectors and alter resource processing systems, in accordance with one or more embodiments. For example, Computer System 102, a part of system 150, may include Machine Learning Model 112, Real-time Resource Processing Subsystem 114, and Explainability Subsystem 116.

System 150 (the system) may receive Training Data 132. Training Data 132 may contain a first set of features, which may be used as input by a machine learning model (e.g., Machine Learning Model 112). Training Data 132 may, for example, include a plurality of resource access requests and account states. A resource access request may, for example, correspond to a first account state and a second account state. A resource access request may be described by parameters and features, the values for which are real numbers, the features and parameters including: an extent of resource access, a category of resource access, a duration and a frequency of the resource access, and an account to which the resource request is directed. A resource access request is expected to cause changes to an account state. Training Data 132 includes records of resource access requests and corresponding records of actual account states. In some instances, a pair of first account state and second account state corresponding to a resource access request accurately reflect the desired changes of the resource access request. In other instances, the resource access request does not cohere with the first account state and/or the second account state or the relation between the two account states. Such resource access requests are considered to be in error and should not be approved. Training Data 132 may include or be associated with a set of approval determinations. Each approval determination in the set may correspond to one or more resource access requests. For example, the system may individually approve or decline each resource access request in Training Data 132. Alternatively or additionally, the system may use batch processing to make an approval determination for a collection of resource access requests. For example, all resource access requests received on the same day are issued one approval determination. In another example, all resource access requests for the same user account are approved or declined together.

The approval determinations in Training Data 132 may be generated by a rule set-based access approval system. The access approval system may perform batched-based assessments of resource access requests to issue approvals, rejections or, in some embodiments, numeric scores symbolizing the likelihood that the resource access request should be approved. The access approval system may use a set of deterministic rules taking into account one or more features describing the resource access request, the first account state and the second account state to generate a binary approval determination. For example, the access approval system may extract the extent of resource access from the resource access request. Upon determining that the extent exceeds the available resources in the first account state, the access approval system may decline the resource access request. In another example, the access approval system may determine that all parameters of the resource access request are in compliance, that the user account is in good standing, and that the difference between the first account state and the second account state accurately reflect the effects of the resource access request. Therefore, the access approval system may approve the resource access request. Training Data 132 may, for example, be generated in a batch format. The access approval system may be designed to use batch-based decision making, reflecting in Training Data 132 having time stamps of fixed periods. For example, the access approval system may make decisions for requests of the same day all at once. In another example, the access approval system may verify decisions for requests on a daily basis. Training Data 132 may be used to train a real-time system designed to replace the batch-based access approval system.

In some embodiments, the system may process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may train a machine learning model (e.g., Machine Learning Model 112) based on Training Data 132. Machine Learning Model 112 may take as input a vector of feature values for a first set of features and output a confidence score indicating a likelihood that a resource access request is correct, given a first account state and a second account state. The first set of features may include quantitative and categorical features describing aspects of the resource access request, the first account state and the second account state. The first set of features may correspond to the features in Training Data 132, excluding the approval determinations. Machine Learning Model 112 may use one or more algorithms like linear regression, generalized additive models, artificial neural networks or random forests to achieve quantitative prediction. The system may partition Training Data 132 into a training set and a cross-validating set. Using the training set, the system may train Machine Learning Model 112 using, for example, the gradient descent technique. The system may then cross-validate the trained model using the cross-validating set and further fine-tune the parameters of the model. Machine Learning Model 112 may include one or more parameters that it uses to translate input into outputs. For example, an artificial neural network contains a matrix of weights, each weight in which is a real number. The repeated multiplication and combination of weights transform input values to Machine Learning Model 112 into output values. The system may measure the performance of Machine Learning Model 112 using a method such as cross-validation to generate a quantitative representation, e.g., a first performance metric.

The system may use a real-time resource processing system (e.g., Real-time Resource Processing Subsystem 114) to process a first resource access request, a first initial account state, and a first subsequent account state from a real-time data stream. The first resource access request, first initial account state, and first subsequent account state may be one trio of data in the real-time data stream, which includes a plurality of resource access requests with corresponding initial account states and subsequent account states received in real time. Real-time Resource Processing Subsystem 114 may use a set of logical operations on the first resource access request, first initial account state, and first subsequent account state to determine whether to approve or decline the first resource access request. For example, Real-time Resource Processing Subsystem 114 may compare the extent and category of the first resource access request against an extent and category of resource in the user account associated with the first initial account state. In response to determining that the extent of the first resource access request exceeds that of the user account, or that the category of the resource access request does not match that of the user account, Real-time Resource Processing Subsystem 114 may determine to reject the first resource access request. Otherwise, Real-time Resource Processing Subsystem 114 may proceed to perform the next logical operation in a predetermined process. For example, the next logical operation that Real-time Resource Processing Subsystem 114 uses may be that the duration and frequency of the first resource access request does not violate preset compliance standards governing resource access requests for certain types of user accounts. In some embodiments, the compliance standards may be due to an aspect of the first initial account state. For example, the user account may be barred from withdrawals of a particular resource during a particular period of time according to a compliance standard of Real-time Resource Processing Subsystem 114. If Real-time Resource Processing Subsystem 114 does not determine to reject the first resource access based on any of its logical operations, Real-time Resource Processing Subsystem 114 may approve the resource access request. In some embodiments, the logical operations of Real-time Resource Processing Subsystem 114 only determine whether the relationship between the first resource access request and the first initial account state satisfy certain logical criteria. In some other embodiments, the logical operations of Real-time Resource Processing Subsystem 114 concern intrinsic aspects of the first resource access request, the first initial account state, and/or the first subsequent account state as well as the relations between one or more of the first resource access request, the first initial account state, and/or the first subsequent account state. For example, Real-time Resource Processing Subsystem 114 may determine a difference between the first initial account state and the first subsequent account state. Real-time Resource Processing Subsystem 114 may compare the difference against the parameters of the first resource access request in order to determine whether the changes that the first resource access request were expected to cause correspond to actual changes from the first initial account state to the first subsequent account state.

Concurrently the system may use Machine Learning Model 112 to process the first resource access request, the first initial account state, and the first subsequent account state from the real-time data stream to generate a first confidence score that the new resource access request was executed correctly. For example, the system may transform the first resource access request, the first initial account state, and the first subsequent account state into the format of the input features to Machine Learning Model 112. For example, the system may map the first resource access request, the first initial account state, and the first subsequent account state into an input vector of quantitative and categorical variables used by Machine Learning Model 112 using a standard embedding approach. Machine Learning Model 112 may then process the input vector to generate a confidence score symbolizing an estimated likelihood that the first resource access request was executed correctly, given the first initial account state and the first subsequent account state. In some embodiments, Machine Learning Model 112 may process a plurality of resource access requests, corresponding to a plurality of initial account states and a plurality of subsequent account states, to generate the confidence score that the approval determination, which Real-time Resource Processing Subsystem 114 made corresponding to the plurality of resource access requests, was correct.

The system may compare the confidence score against a numeric threshold, which is a predetermined real number. If the confidence score is lower than the numeric threshold, the system may determine that the approval determination of Real-time Resource Processing Subsystem 114 was incorrect. In some embodiments, the system may take an absolute value of the difference between the confidence score and the numeric threshold to be a discrepancy, where the discrepancy is directly proportional to how incorrect Real-time Resource Processing Subsystem 114 was in the approval determination. In some embodiments, if the confidence score is lower than the numeric threshold or if the discrepancy exceeds a certain number, the system may revoke the approval determination of Real-time Resource Processing Subsystem 114 and reverse the effects of approving or rejecting the first resource access request. Alternatively, by revoking the approval determination of Real-time Resource Processing Subsystem 114, the system may use a different access approval system to make an approval determination for the first resource access request. Additionally or alternatively, the system may extract a runtime explainability vector from the processing of the real-time data stream by Machine Learning Model 112 to encapsulate how Machine Learning Model 112 generated the first confidence score.

The system may process Machine Learning Model 112 to extract a runtime explainability vector (e.g., Explainability Vector 134), for example using Explainability Subsystem 116. The system may use Explainability Vector 134 to understand the decision-making of Machine Learning Model 112 when generating confidence scores for approval determinations.

Explainability Subsystem 116 may employ a variety of explainability techniques depending on the algorithms in Machine Learning Model 112 to extract Explainability Vector 134. Explainability Vector 134 contains one entry for each feature in the set of features in the input to Machine Learning Model 112, and the entry reflects the importance of that feature to the model. The values within Explainability Vector 134 may additionally represent how each feature correlates to the output of the model, and the causative effect of each feature in producing the output as construed by the model. In some embodiments, a correlation matrix may be attached to Explainability Vector 134. The correlation matrix captures how variables are correlated with other variables. This is relevant because correlation between variables in a model causes interference in their causative effects in producing the output of the model.

Below are some examples of how Explainability Subsystem 116 extracts an explainability vector in Explainability Vector 134 from Machine Learning Model 112.

For example, the candidate model may contain a matrix of weights for a multivariate regression algorithm. Explainability Subsystem 116 may use a Shapley Additive Explanation method to extract Explainability Vector 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. Explainability Vector 134 may be a list of normalized Shapley values of each feature.

In another example, the candidate model may contain a vector(s) of coefficients for a generalized additive model. Since the nature of generalized additive models is such that the effect of each variable on the output is completely and independently captured by its coefficient, Explainability Subsystem 116 may take the list of coefficients to be Explainability Vector 134.

In another example, the candidate model may contain a matrix of weights for a supervised classifier algorithm. Explainability Subsystem 116 may use a Local Interpretable Model-agnostic Explanations method to extract Explainability Vector 134. The Local Interpretable Model-agnostic Explanations approximates the results of the candidate model with an explainable model, e.g., a decision tree classifier. The approximate model is trained using a loss heuristic that judges similarity to the candidate model and that penalizes complexity. In some embodiments, the number of variables that the approximate model uses can be specified. The approximate model will clearly define the effect of each feature on the output: for example, the approximate model may be a generalized additive model.

In another example, the candidate model may contain a matrix of weights for a convolutional neural network algorithm. Explainability Subsystem 116 may use a Gradient Class Activation Mapping method to extract Explainability Vector 134. The Grad-CAM technique performs backpropagation on the output of the model with respect to the final convolutional feature map to compute derivatives of features in the input with respect to the output of the model. The derivatives may then be used as indications of importance of features to a model, and Explainability Vector 134 may be a list of such derivatives.

In another example, the candidate model may contain a set of parameters comprising a hyperplane matrix for a support vector(s) machine algorithm. Explainability Subsystem 116 may use a counterfactual explanation method to extract Explainability Vector 134. The counterfactual explanation method looks for input data which are identical or extremely close in values for all features except one. Then the difference in prediction results may be divided by the difference in the divergent value. This process is repeated on each feature for all pairs of available input vector(s), and the aggregated result is a measure for the effect of each feature on the output of the model, which may be formed into Explainability Vector 134.

Based on the discrepancy and Explainability Vector 134, the system may adjust the set of logical operations of Real-time Resource Processing Subsystem 114. The system may, for example, identify one or more erroneous components of Real-time Resource Processing Subsystem 114 using Explainability Vector 134. The system may use values in Explainability Vector 134 to identify features contributing to the confidence score generated by Machine Learning Model 112. The system may take, for example, a predetermined number of the highest ranking features in Explainability Vector 134 to be model factors, where each model factor indicates a feature in Machine Learning Model 112 which contributed to the low confidence score for the approval determination of the first resource access request. The model factors, therefore, contribute to the disparity between the expected approval determination from Machine Learning Model 112 and the approval determination made by Real-time Resource Processing Subsystem 114. The system may thus identify for adjustment logical operations in the process used by Real-time Resource Processing Subsystem 114 to generate approval determinations corresponding to the model factors.

For example, the system may identify all logical operations in Real-time Resource Processing Subsystem 114 that relate to a model factor. The logical operations identified this way (also referred to as decision components) for all model factors may all be considered eligible for adjustment. The system may use the discrepancy to determine the magnitude of change, where the discrepancy is directly proportional to how dissimilar Real-time Resource Processing Subsystem 114 was in the approval determination from Machine Learning Model 112. For example, the higher the discrepancy, the more severely the system may adjust the values of logical operations in Real-time Resource Processing Subsystem 114. The system may increase or decrease threshold values in logical operations of Real-time Resource Processing Subsystem 114 to an extent proportional to the discrepancy. In some embodiments, the system may use a reinforcement learning algorithm to update decision components of Real-time Resource Processing Subsystem 114 based on the discrepancy as Explainability Vector 134. For example, the reinforcement learning algorithm may use the discrepancy as a loss function score. For example, the reinforcement learning algorithm may permute decision components of Real-time Resource Processing Subsystem 114 in order to reduce the discrepancy, which is the loss function score.

In some embodiments, there may be an intent change in Real-time Resource Processing Subsystem 114 that is a correct change from the prior method used in the rule set-based access approval system. In order to monitor for such a change and heal or (self-heal) to address the change, Delta Monitoring System 138 may determine cases with large deltas in “rejects” may need to be investigated as high risk due to intent or other changes. These rejects may be categorized and stored in High Aberration Reject Queue 136. Intent Change Detection System 140 may review the categorized high risk reject queue in High Aberration Reject Queue 136. Intent Change Detection System 140 may be manual or automated by leveraging LLMs against intent systems of records, policy binders, etc. which could glean insights and determine the rejects were in reality a correct intent change. Once there is a determination (manually or otherwise) that a reject was an error, the data set may be augmented with new data and any data from the training set which caused the reject may be cleansed.

In some embodiments, while intent change detection may be advantageous for alerting, automating that system may run the risk of context drift, i.e., normalizing erroneous behavior over time. Intent Repository/SOR 142 attached to Intent Change Detection System 140 may provide the governance aspect described above but also compare against the original models. If a drift within policy is detected, but distance metric from original model to updated model ever crosses a threshold, it may signal a needed update either to the base training set or governance policies to allow for it.

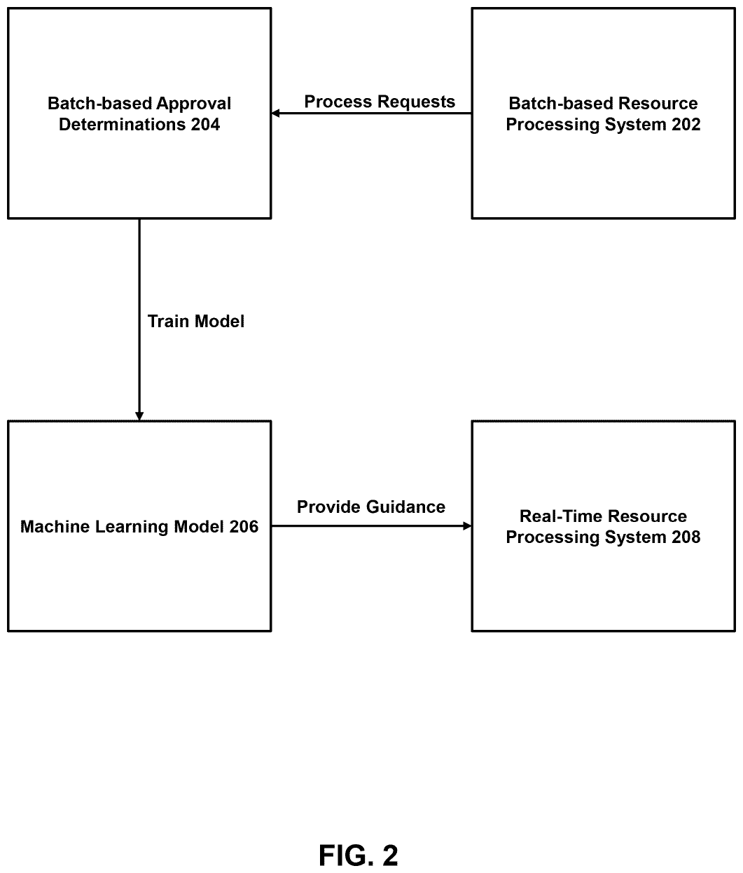

FIG. 2 shows a process by which a batch-based resource processing system's logic is used to guide a real-time resource processing system. Batch-based Resource Processing System 202 may perform batched-based assessments of resource access requests to issue approvals, rejections or, in some embodiments, numeric scores symbolizing the likelihood that the resource access request should be approved. Batch-based Resource Processing System 202 may use a set of deterministic rules taking into account one or more features describing the resource access request, the first account state and the second account state to generate a binary approval determination. For example, Batch-based Resource Processing System 202 may extract the extent of resource access from the resource access request. Upon determining that the extent exceeds the available resources in the first account state, Batch-based Resource Processing System 202 may decline the resource access request. In another example, Batch-based Resource Processing System 202 may determine that all parameters of the resource access request are in compliance, that the user account is in good standing, and that the difference between the first account state and the second account state accurately reflect the effects of the resource access request. Therefore, the system may approve the resource access request. Batch-based Resource Processing System 202 may process resource access requests at regular time intervals, for example daily. The results for each access request may be stored alongside account states associated with the access request. For example, the first account state and second account state associated with each access request may be stored in Batch-based Approval Determinations 204 in addition to the approve/decline determination. This allows the system to capture the reasons for approval determinations and is crucial for training a machine learning model based on Batch-based Approval Determinations 204.

Using Batch-based Approval Determinations 204, the system may train a machine learning model (e.g., Machine Learning Model 206). Machine Learning Model 206 may take as input a vector of feature values for a first set of features and output a confidence score indicating a likelihood that a resource access request is correct, given a first account state and a second account state. The first set of features may include quantitative and categorical features describing aspects of the resource access request, the first account state and the second account state. The first set of features may correspond to the features in Training Data 132, excluding the approval determinations. Machine Learning Model 206 may use one or more algorithms like linear regression, generalized additive models, artificial neural networks or random forests to achieve quantitative prediction. The system may partition Training Data 132 into a training set and a cross-validating set. Using the training set, the system may train Machine Learning Model 206 using, for example, the gradient descent technique. The system may then cross-validate the trained model using the cross-validating set and further fine-tune the parameters of the model. Machine Learning Model 206 may include one or more parameters that it uses to translate input into outputs. For example, an artificial neural network contains a matrix of weights, each weight in which is a real number. The repeated multiplication and combination of weights transform input values to Machine Learning Model 206 into output values. The system may measure the performance of Machine Learning Model 206 using a method such as cross-validation to generate a quantitative representation, e.g., a first performance metric.

The system may use a loss function to enforce compliance from the output of Machine Learning Model 206 to the approval decisions of Batch-based Approval Determinations 204. The loss functions aim to reduce errors, which are instances where the output of Machine Learning Model 206 differs from the approval decision recorded in Batch-based Approval Determinations 204. The result is that Machine Learning Model 206 faithfully captures the decision making of Batch-based Resource Processing System 202, and will issue approval determinations for resource requests in a manner highly similar to Batch-based Resource Processing System 202.

The system may use a real-time resource processing system (e.g., Real-time Resource Processing Subsystem 114) to process a first resource access request, a first initial account state, and a first subsequent account state from a real-time data stream. The first resource access request, first initial account state, and first subsequent account state may be one trio of data in the real-time data stream, which includes a plurality of resource access requests with corresponding initial account states and subsequent account states received in real time. Real-time Resource Processing Subsystem 114 may use a set of logical operations on the first resource access request, first initial account state, and first subsequent account state to determine whether to approve or decline the first resource access request. For example, Real-time Resource Processing Subsystem 114 may compare the extent and category of the first resource access request against an extent and category of resource in the user account associated with the first initial account state. In response to determining that the extent of the first resource access request exceeds that of the user account, or that the category of the resource access request does not match that of the user account, Real-time Resource Processing Subsystem 114 may determine to reject the first resource access request.

The system may use Machine Learning Model 206 to provide guidance to Real-time Resource Processing Subsystem 208. The system may use Machine Learning Model 112 to process the first resource access request, the first initial account state, and the first subsequent account state from the real-time data stream to generate a first confidence score that the new resource access request was executed correctly. For example, the system may transform the first resource access request, the first initial account state, and the first subsequent account state into the format of the input features to Machine Learning Model 206. For example, the system may map the first resource access request, the first initial account state, and the first subsequent account state into an input vector of quantitative and categorical variables used by Machine Learning Model 206 using a standard embedding approach. Machine Learning Model 206 may then process the input vector to generate a confidence score symbolizing an estimated likelihood that the first resource access request was executed correctly, given the first initial account state and the first subsequent account state. The system may compare the confidence score against a numeric threshold, which is a predetermined real number. If the confidence score is lower than the numeric threshold, the system may determine that the approval determination of Real-time Resource Processing Subsystem 208 was incorrect. In some embodiments, the system may take an absolute value of the difference between the confidence score and the numeric threshold to be a discrepancy, where the discrepancy is directly proportional to how incorrect Real-time Resource Processing Subsystem 208 was in the approval determination. In some embodiments, if the confidence score is lower than the numeric threshold or if the discrepancy exceeds a certain number, the system may revoke the approval determination of Real-time Resource Processing Subsystem 208 and reverse the effects of approving or rejecting the first resource access request. Alternatively, by revoking the approval determination of Real-time Resource Processing Subsystem 208, the system may use a different access approval system to make an approval determination for the first resource access request. Additionally or alternatively, the system may extract a runtime explainability vector from the processing of the real-time data stream by Machine Learning Model 206 to encapsulate how Machine Learning Model 206 generated the first confidence score.

Based on the runtime explainability vector, the system may adjust the set of logical operations of Real-time Resource Processing Subsystem 208. The system may use values in Explainability Vector 134 to identify features contributing to the confidence score generated by Machine Learning Model 206. The system may take, for example, a predetermined number of the highest ranking features in Explainability Vector 134 to be model factors, where each model factor indicates a feature in Machine Learning Model 206 which contributed to the low confidence score for the approval determination of the first resource access request. The model factors, therefore, contribute to the disparity between the expected approval determination from Machine Learning Model 206 and the approval determination made by Real-time Resource Processing Subsystem 208. The system may thus identify for adjustment logical operations in the process used by Real-time Resource Processing Subsystem 208 to generate approval determinations corresponding to the model factors. For example, the system may identify all logical operations in Real-time Resource Processing Subsystem 208 that relate to a model factor. The logical operations identified this way (also referred to as decision components) for all model factors may all be considered eligible for adjustment. The system may use the discrepancy to determine the magnitude of change, where the discrepancy is directly proportional to how dissimilar Real-time Resource Processing Subsystem 208 was in the approval determination from Machine Learning Model 206.

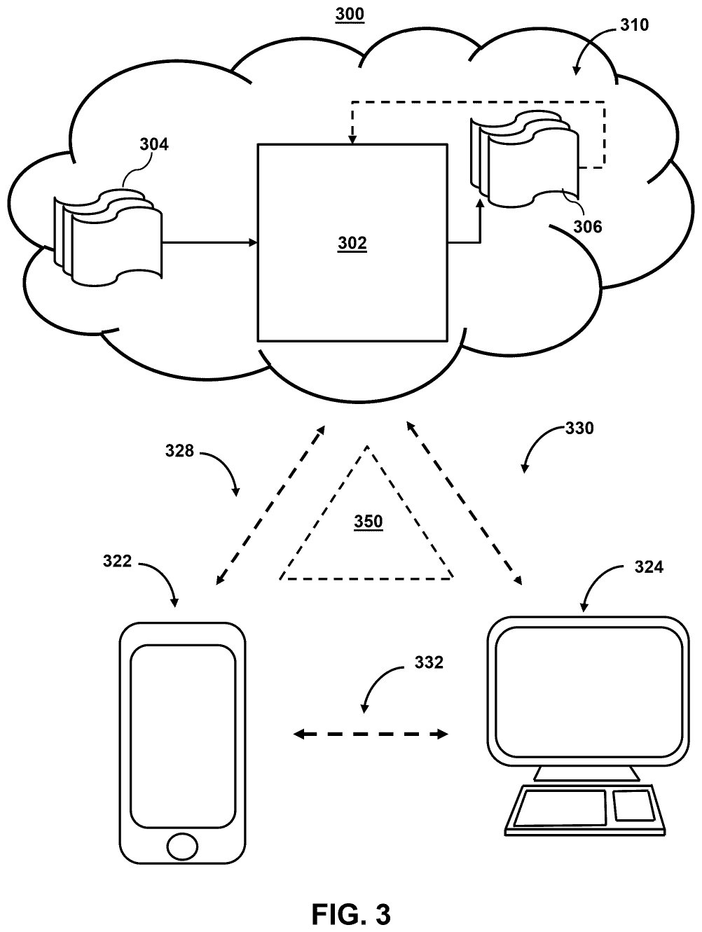

FIG. 3 shows illustrative components for a system used to train machine learning models, extract explainability vectors and alter resource processing systems, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the Machine learning model to classify the first labeled feature input with the known prediction (e.g., approval decisions for access requests).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., whether to approve or decline a resource access request).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DdoS protection, and API layer 350 may use RESTful APIs as standard for external integration.

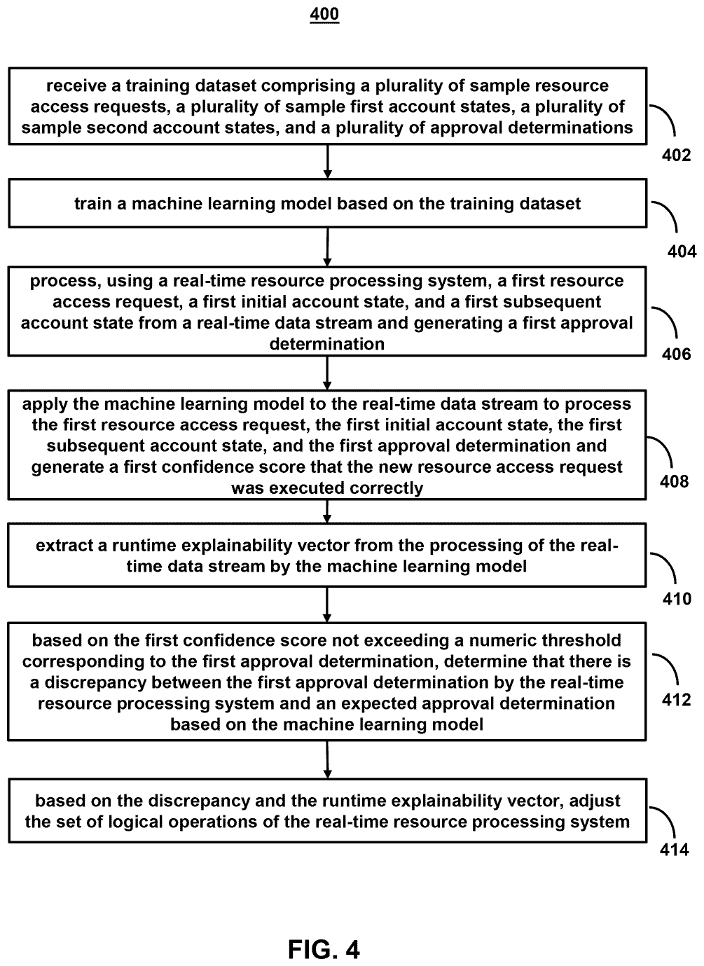

FIG. 4 shows a flowchart of the steps involved in training machine learning models, extracting explainability vectors and altering resource processing systems, in accordance with one or more embodiments. For example, the system may use process 400 (e.g., as implemented on one or more system components described above) in order to collect and process data about users, train Machine Learning Models, extract explainability vectors, and select and recombine features.

At step 402, process 400 (e.g., using one or more components described above) may receive a training dataset (e.g., Training Data 132) comprising a plurality of sample resource access requests, a plurality of sample first account states, a plurality of sample second account states, and a plurality of approval determinations. Training Data 132 may contain a first set of features, which may be used as input by a machine learning model (e.g., Machine Learning Model 112). Training Data 132 may, for example, include a plurality of resource access requests and account states. A resource access request may, for example, correspond to a first account state and a second account state. A resource access request may be described by parameters and features, the values for which are real numbers, the features and parameters including: an extent of resource access, a category of resource access, a duration and a frequency of the resource access, and an account to which the resource request is directed. A resource access request is expected to causes changes to an account state. Training Data 132 includes records of resource access requests and corresponding records of actual account states. In some instances, a pair of first account state and second account state corresponding to a resource access request accurately reflect the desired changes of the resource access request. In other instances, the resource access request does not cohere with the first account state and/or the second account state or the relation between the two account states. Such resource access requests are considered to be in error and should not be approved. Training Data 132 may include or be associated with a set of approval determinations. Each approval determination in the set may correspond to one or more resource access requests. For example, the system may individually approve or decline each resource access request in Training Data 132. Alternatively or additionally, the system may use batch processing to make an approval determination for a collection of resource access requests. For example, all resource access requests received on the same day are issued one approval determination. In another example, all resource access requests for the same user account are approved or declined together.

The approval determinations in Training Data 132 may be generated by a rule set-based access approval system. The access approval system may perform batched-based assessments of resource access requests to issue approvals, rejections or, in some embodiments, numeric scores symbolizing the likelihood that the resource access request should be approved. The access approval system may use a set of deterministic rules taking into account one or more features describing the resource access request, the first account state and the second account state to generate a binary approval determination. For example, the access approval system may extract the extent of resource access from the resource access request. Upon determining that the extent exceeds the available resources in the first account state, the access approval system may decline the resource access request. In another example, the access approval system may determine that all parameters of the resource access request are in compliance, that the user account is in good standing, and that the difference between the first account state and the second account state accurately reflect the effects of the resource access request. Therefore, the access approval system may approve the resource access request. Training Data 132 may, for example, be generated in a batch format. The access approval system may be designed to use batch-based decision making, reflecting in Training Data 132 having time stamps of fixed periods. For example, the access approval system may make decisions for requests of the same day all at once. In another example, the access approval system may verify decisions for requests on a daily basis. Training Data 132 may be used to train a real-time system designed to replace the batch-based access approval system.

In some embodiments, the system may process Training Data 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

At step 404, process 400 (e.g., using one or more components described above) may train a machine learning model based on the training dataset. The system may train a machine learning model (e.g., Machine Learning Model 112) based on Training Data 132. Machine Learning Model 112 may take as input a vector of feature values for a first set of features and output a confidence score indicating a likelihood that a resource access request is correct, given a first account state and a second account state. The first set of features may include quantitative and categorical features describing aspects of the resource access request, the first account state and the second account state. The first set of features may correspond to the features in Training Data 132, excluding the approval determinations. Machine Learning Model 112 may use one or more algorithms like linear regression, generalized additive models, artificial neural networks or random forests to achieve quantitative prediction. The system may partition Training Data 132 into a training set and a cross-validating set. Using the training set, the system may train Machine Learning Model 112 using, for example, the gradient descent technique. The system may then cross-validate the trained model using the cross-validating set and further fine-tune the parameters of the model. Machine Learning Model 112 may include one or more parameters that it uses to translate input into outputs. For example, an artificial neural network contains a matrix of weights, each weight in which is a real number. The repeated multiplication and combination of weights transform input values to Machine Learning Model 112 into output values. The system may measure the performance of Machine Learning Model 112 using a method such as cross-validation to generate a quantitative representation, e.g., a first performance metric.

At step 406, process 400 (e.g., using one or more components described above) may process, using a real-time resource processing system, a first resource access request, a first initial account state, and a first subsequent account state from a real-time data stream and generating a first approval determination. The system may use a real-time resource processing system (e.g., Real-time Resource Processing Subsystem 114) to process a first resource access request, a first initial account state, and a first subsequent account state from a real-time data stream. The first resource access request, first initial account state, and first subsequent account state may be one trio of data in the real-time data stream, which includes a plurality of resource access requests with corresponding initial account states and subsequent account states received in real time. Real-time Resource Processing Subsystem 114 may use a set of logical operations on the first resource access request, first initial account state, and first subsequent account state to determine whether to approve or decline the first resource access request. For example, Real-time Resource Processing Subsystem 114 may compare the extent and category of the first resource access request against an extent and category of resource in the user account associated with the first initial account state. In response to determining that the extent of the first resource access request exceeds that of the user account, or that the category of the resource access request does not match that of the user account, Real-time Resource Processing Subsystem 114 may determine to reject the first resource access request. Otherwise, Real-time Resource Processing Subsystem 114 may proceed to perform the next logical operation in a predetermined process. For example, the next logical operation that Real-time Resource Processing Subsystem 114 uses may be that the duration and frequency of the first resource access request does not violate preset compliance standards governing resource access requests for certain types of user accounts. In some embodiments, the compliance standards may be due to an aspect of the first initial account state. For example, the user account may be barred from withdrawals of a particular resource during a particular period of time according to a compliance standard of Real-time Resource Processing Subsystem 114. If Real-time Resource Processing Subsystem 114 does not determine to reject the first resource access based on any of its logical operations, Real-time Resource Processing Subsystem 114 may approve the resource access request. In some embodiments, the logical operations of Real-time Resource Processing Subsystem 114 only determine whether the relationship between the first resource access request and the first initial account state satisfy certain logical criteria. In some other embodiments, the logical operations of Real-time Resource Processing Subsystem 114 concern intrinsic aspects of the first resource access request, the first initial account state, and/or the first subsequent account state as well as the relations between one or more of the first resource access request, the first initial account state, and/or the first subsequent account state. For example, Real-time Resource Processing Subsystem 114 may determine a difference between the first initial account state and the first subsequent account state. Real-time Resource Processing Subsystem 114 may compare the difference against the parameters of the first resource access request in order to determine whether the changes that the first resource access request were expected to cause correspond to actual changes from the first initial account state to the first subsequent account state.

At step 408, process 400 (e.g., using one or more components described above) may apply the machine learning model to the real-time data stream to process the first resource access request, the first initial account state, the first subsequent account state, and the first approval determination and generate a first confidence score that the new resource access request was executed correctly. Concurrently the system may use Machine Learning Model 112 to process the first resource access request, the first initial account state, and the first subsequent account state from the real-time data stream to generate a first confidence score that the new resource access request was executed correctly. For example, the system may transform the first resource access request, the first initial account state, and the first subsequent account state into the format of the input features to Machine Learning Model 112. For example, the system may map the first resource access request, the first initial account state, and the first subsequent account state into an input vector of quantitative and categorical variables used by Machine Learning Model 112 using a standard embedding approach. Machine Learning Model 112 may then process the input vector to generate a confidence score symbolizing an estimated likelihood that the first resource access request was executed correctly, given the first initial account state and the first subsequent account state. In some embodiments, Machine Learning Model 112 may process a plurality of resource access requests, corresponding to a plurality of initial account states and a plurality of subsequent account states, to generate the confidence score that the approval determination, which Real-time Resource Processing Subsystem 114 made corresponding to the plurality of resource access requests, was correct.

At step 410, process 400 (e.g., using one or more components described above) may extract a runtime explainability vector from the processing of the real-time data stream by the machine learning model. The system may process Machine Learning Model 112 to extract a runtime explainability vector (e.g., Explainability Vector 134), for example using Explainability Subsystem 116. The system may use Explainability Vector 134 to understand the decision-making of Machine Learning Model 112 when generating confidence scores for approval determinations.

Explainability Subsystem 116 may employ a variety of explainability techniques depending on the algorithms in Machine Learning Model 112 to extract Explainability Vector 134. Explainability Vector 134 contains one entry for each feature in the set of features in the input to Machine Learning Model 112, and the entry reflects the importance of that feature to the model. The values within Explainability Vector 134 may additionally represent how each feature correlates to the output of the model, and the causative effect of each feature in producing the output as construed by the model. In some embodiments, a correlation matrix may be attached to Explainability Vector 134. The correlation matrix captures how variables are correlated with other variables. This is relevant because correlation between variables in a model causes interference in their causative effects in producing the output of the model.

Below are some examples of how Explainability Subsystem 116 extracts an explainability vector in Explainability Vector 134 from Machine Learning Model 112.

For example, the candidate model may contain a matrix of weights for a multivariate regression algorithm. Explainability Subsystem 116 may use a Shapley Additive Explanation method to extract Explainability Vector 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. Explainability Vector 134 may be a list of normalized Shapley values of each feature.

In another example, the candidate model may contain a vector(s) of coefficients for a generalized additive model. Since the nature of generalized additive models is such that the effect of each variable on the output is completely and independently captured by its coefficient, Explainability Subsystem 116 may take the list of coefficients to be Explainability Vector 134.

In another example, the candidate model may contain a matrix of weights for a supervised classifier algorithm. Explainability Subsystem 116 may use a Local Interpretable Model-agnostic Explanations method to extract Explainability Vector 134. The Local Interpretable Model-agnostic Explanations approximates the results of the candidate model with an explainable model, e.g., a decision tree classifier. The approximate model is trained using a loss heuristic that judges similarity to the candidate model and that penalizes complexity. In some embodiments, the number of variables that the approximate model uses can be specified. The approximate model will clearly define the effect of each feature on the output: for example, the approximate model may be a generalized additive model.

In another example, the candidate model may contain a matrix of weights for a convolutional neural network algorithm. Explainability Subsystem 116 may use a Gradient Class Activation Mapping method to extract Explainability Vector 134. The Grad-CAM technique performs backpropagation on the output of the model with respect to the final convolutional feature map to compute derivatives of features in the input with respect to the output of the model. The derivatives may then be used as indications of importance of features to a model, and Explainability Vector 134 may be a list of such derivatives.

In another example, the candidate model may contain a set of parameters comprising a hyperplane matrix for a support vector(s) machine algorithm. Explainability Subsystem 116 may use a counterfactual explanation method to extract Explainability Vector 134. The counterfactual explanation method looks for input data which are identical or extremely close in values for all features except one. Then the difference in prediction results may be divided by the difference in the divergent value. This process is repeated on each feature for all pairs of available input vector(s)s, and the aggregated result is a measure for the effect of each feature on the output of the model, which may be formed into Explainability Vector 134.

At step 412, process 400 (e.g., using one or more components described above) may, based on the first confidence score not exceeding a numeric threshold corresponding to the first approval determination, determine that there is a discrepancy between the first approval determination by the real-time resource processing system and an expected approval determination based on the machine learning model. The system may compare the confidence score against a numeric threshold, which is a predetermined real number. If the confidence score is lower than the numeric threshold, the system may determine that the approval determination of Real-time Resource Processing Subsystem 114 was incorrect. In some embodiments, the system may take an absolute value of the difference between the confidence score and the numeric threshold to be a discrepancy, where the discrepancy is directly proportional to how incorrect Real-time Resource Processing Subsystem 114 was in the approval determination. In some embodiments, if the confidence score is lower than the numeric threshold or if the discrepancy exceeds a certain number, the system may revoke the approval determination of Real-time Resource Processing Subsystem 114 and reverse the effects of approving or rejecting the first resource access request. Alternatively, by revoking the approval determination of Real-time Resource Processing Subsystem 114, the system may use a different access approval system to make an approval determination for the first resource access request.

At step 414, process 400 (e.g., using one or more components described above) may, based on the discrepancy and the runtime explainability vector, adjust the set of logical operations of the real-time resource processing system. Based on the discrepancy and Explainability Vector 134, the system may adjust the set of logical operations of Real-time Resource Processing Subsystem 114. The system may, for example, identify one or more erroneous components of Real-time Resource Processing Subsystem 114 using Explainability Vector 134. The system may use values in Explainability Vector 134 to identify features contributing to the confidence score generated by Machine Learning Model 112. The system may take, for example, a predetermined number of the highest ranking features in Explainability Vector 134 to be model factors, where each model factor indicates a feature in Machine Learning Model 112 which contributed to the low confidence score for the approval determination of the first resource access request. The model factors, therefore, contribute to the disparity between the expected approval determination from Machine Learning Model 112 and the approval determination made by Real-time Resource Processing Subsystem 114. The system may thus identify for adjustment logical operations in the process used by Real-time Resource Processing Subsystem 114 to generate approval determinations corresponding to the model factors.

For example, the system may identify all logical operations in Real-time Resource Processing Subsystem 114 that relate to a model factor. The logical operations identified this way (also referred to as decision components) for all model factors may all be considered eligible for adjustment. The system may use the discrepancy to determine the magnitude of change, where the discrepancy is directly proportional to how dissimilar Real-time Resource Processing Subsystem 114 was in the approval determination from Machine Learning Model 112. For example, the higher the discrepancy, the more severely the system may adjust the values of logical operations in Real-time Resource Processing Subsystem 114. The system may increase or decrease threshold values in logical operations of Real-time Resource Processing Subsystem 114 to an extent proportional to the discrepancy. In some embodiments, the system may use a reinforcement learning algorithm to update decision components of Real-time Resource Processing Subsystem 114 based on the discrepancy as Explainability Vector 134. For example, the reinforcement learning algorithm may use the discrepancy as a loss function score. For example, the reinforcement learning algorithm may permute decision components of Real-time Resource Processing Subsystem 114 in order to reduce the discrepancy, which is the loss function score.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: receiving a training dataset comprising a plurality of sample resource access requests, a plurality of sample first account states, a plurality of sample second account states, and a plurality of approval determinations associated with a batch-based resource processing system, wherein each approval determination in the plurality of approval determinations corresponds to one or more resource access requests in the plurality of sample resource access requests; training a machine learning model based on the training dataset, wherein the machine learning model processes a resource access request, a first input account state, a second input account state, and an approval determination to generate a confidence score that the resource access request was executed correctly; processing, using a real-time resource processing system, a new resource access request, a new first account state, and a new second account state from a real-time data stream and generating a new approval determination, wherein the real-time resource processing system determines to approve or decline resource access requests based on a set of logical operations; applying the machine learning model to the real-time data stream to process the new resource access request, the new first account state, the new second account state, and the new approval determination and generate a new confidence score that the new resource access request was executed correctly; extracting a runtime explainability vector from the processing of the real-time data stream by the machine learning model; based on the new confidence score not exceeding a numeric threshold corresponding to the new approval determination, determining that there is a discrepancy between the approval determination by the real-time resource processing system and an expected approval determination based on the machine learning model; and based on the discrepancy and the runtime explainability vector, adjusting the plurality of logical operations of the real-time resource processing system.

2. A method comprising: receiving a training dataset comprising a plurality of sample resource access requests, a plurality of sample first account states, a plurality of sample second account states, and a plurality of approval determinations, wherein each approval determination in the plurality of approval determinations corresponds to one or more resource access requests in the plurality of sample resource access requests; training a machine learning model based on the training dataset, wherein the machine learning model processes a resource access request, an input initial account state, an input subsequent account state, and an approval determination to generate a confidence score that the resource access request was executed correctly; processing, using a real-time resource processing system, a first resource access request, a first initial account state, and a first subsequent account state from a real-time data stream and generating a first approval determination, wherein the real-time resource processing system determines to approve or decline resource access requests based on a set of logical operations; applying the machine learning model to the real-time data stream to process the first resource access request, the first initial account state, the first subsequent account state, and the first approval determination and generating a first confidence score that the new resource access request was executed correctly; extracting a runtime explainability vector from the processing of the real-time data stream by the machine learning model; based on the first confidence score not exceeding a numeric threshold corresponding to the first approval determination, determining that there is a discrepancy between the first approval determination by the real-time resource processing system and an expected approval determination based on the machine learning model; and based on the discrepancy and the runtime explainability vector, adjusting the set of logical operations of the real-time resource processing system.

3. The method of any one of the preceding embodiments, wherein: the training dataset comprises a plurality of datasets, each dataset in which comprises a plurality of sample first account states, a plurality of sample second account states corresponding to an approval determination vector.

4. The method of any one of the preceding embodiments, wherein training the machine learning model comprises: training a first plurality of candidate machine learning models, each candidate machine learning model trained using an unlabeled batch dataset and its corresponding label plurality; generating a weighted average plurality of parameters by combining parameters defining each candidate machine learning model in the first plurality of candidate machine learning models using weights corresponding to the plurality of datasets; and generating the machine learning model using the weighted average plurality of parameters.

5. The method of any one of the preceding embodiments, wherein using a real-time resource processing system to generate the plurality of approval determinations comprises: comparing a first plurality of deterministic rules against a resource access request, wherein the first plurality of deterministic rules specifies requirements of a user account associated with the resource access request; comparing a second plurality of deterministic rules against a first account state and a second account state, wherein the first account state and the second account state are associated with the resource access request, and wherein the second plurality of deterministic rules specifies relations between the first account state and the second account state; and in response to the resource access request satisfying the first plurality of deterministic rules and the first account state and the second account state satisfying first plurality of deterministic rules, determining to approve the resource access request.

6. The method of any one of the preceding embodiments, wherein identifying the plurality of discrepancies comprises: computing a mathematical difference between the plurality of confidence scores and an encoding vector for the plurality of approval determinations, wherein the encoding vector represents an approval decision as one and a denial decision as zero; and generating the plurality of discrepancies to be the mathematical difference.

7. The method of any one of the preceding embodiments, wherein adjusting the real-time resource processing system based on the plurality of discrepancies and the runtime explainability vector comprises: for each discrepancy in the plurality of discrepancies, identifying a model factor using the runtime explainability vector, wherein the model factor illustrates a consideration of the machine learning model leading to the discrepancy; identifying a decision component of the real-time resource processing system corresponding to the model factor, wherein the decision component is a mathematical operation used in approval determinations made by the real-time resource processing system; and using a reinforcement learning regimen, updating the decision component.

8. The method of any one of the preceding embodiments, further comprising: using the plurality of discrepancies as a loss function, updating the machine learning model.

9. The method of any one of the preceding embodiments, wherein: the machine learning model is defined by a plurality of parameters comprising a matrix of weights for a multivariate regression algorithm; and the runtime explainability vector is extracted from the machine learning model using a Shapley Additive Explanation method.

10. The method of any one of the preceding embodiments, wherein: the machine learning model is defined by a plurality of parameters comprising a matrix of weights for a supervised classifier algorithm; and the runtime explainability vector is extracted from the machine learning model using a Local Interpretable Model-agnostic Explanations method.

11. The method of any one of the preceding embodiments, wherein: the machine learning model is defined by a plurality of parameters comprising a matrix of weights for a convolutional neural network algorithm; and the runtime explainability vector is extracted from the machine learning model using a Gradient Class Activation Mapping method.

12. The method of any one of the preceding embodiments, wherein: the machine learning model is defined by a plurality of parameters comprising a hyperplane matrix for a support vector machine algorithm; and the runtime explainability vector is extracted from the machine learning model using a counterfactual explanation method.

13. One or more tangible, non-transitory, computer-readable media storing instructions that, when executed by a data processing apparatus, cause the data processing apparatus to perform operations comprising those of any of embodiments 1-12.

14. A system comprising one or more processors; and memory storing instructions that, when executed by the processors, cause the processors to effectuate operations comprising those of any of embodiments 1-12.

15. A system comprising means for performing any of embodiments 1-12.

What is claimed is:

1. A system for monitoring and mitigating output variance between batch-based and real-time resource processing systems, comprising:
one or more processors; and
one or more non-transitory, computer-readable media comprising instructions that, when executed by the one or more processors, cause operations comprising:
receiving a training dataset comprising a plurality of sample resource access requests, a plurality of sample first account states, a plurality of sample second account states, and a plurality of approval determinations associated with a batch-based resource processing system, wherein each approval determination in the plurality of approval determinations corresponds to one or more resource access requests in the plurality of sample resource access requests;
training a machine learning model based on the training dataset, wherein the machine learning model processes a resource access request, a first input account state, a second input account state, and an approval determination to generate a confidence score that the resource access request was executed correctly;
processing, using a real-time resource processing system, a new resource access request, a new first account state, and a new second account state from a real-time data stream and generating a new approval determination, wherein the real-time resource processing system determines to approve or decline resource access requests based on a plurality of logical operations;
applying the machine learning model to the real-time data stream to process the new resource access request, the new first account state, the new second account state, and the new approval determination and generate a new confidence score that the new resource access request was executed correctly;
extracting a runtime explainability vector from the processing of the real-time data stream by the machine learning model;
based on the new confidence score not exceeding a numeric threshold corresponding to the new approval determination, determining that there is a discrepancy between the approval determination by the real-time resource processing system and an expected approval determination based on the machine learning model; and
based on the discrepancy and the runtime explainability vector, adjusting the plurality of logical operations of the real-time resource processing system.

2. A method, comprising:
receiving a training dataset comprising a plurality of sample resource access requests, a plurality of sample first account states, a plurality of sample second account states, and a plurality of approval determinations associated with a first resource processing system, wherein each approval determination in the plurality of approval determinations corresponds to one or more resource access requests in the plurality of sample resource access requests;
training a machine learning model based on the training dataset, wherein the machine learning model processes a resource access request, an input initial account state, an input subsequent account state, and an approval determination to generate a confidence score that the resource access request was executed correctly;
processing, using a second resource processing system, a first resource access request, a first initial account state, and a first subsequent account state and generating a first approval determination, wherein the second resource processing system determines to approve or decline resource access requests based on a set of logical operations;
applying the machine learning model to process the first resource access request, the first initial account state, the first subsequent account state, and the first approval determination and generating a first confidence score that the first resource access request was executed correctly;
extracting a runtime explainability vector from the processing by the machine learning model;
based on the first confidence score not exceeding a numeric threshold corresponding to the first approval determination, determining that there is a discrepancy between the first approval determination by the second resource processing system and an expected approval determination based on the machine learning model; and
based on the discrepancy and the runtime explainability vector, adjusting the set of logical operations of the second resource processing system.

3. The method of claim 2, wherein:
the training dataset comprises a plurality of datasets, each dataset in which comprises a plurality of sample first account states and a plurality of sample second account states corresponding to an approval determination vector.

4. The method of claim 3, wherein training the machine learning model comprises:
training a first plurality of candidate machine learning models, each candidate machine learning model trained using an unlabeled batch dataset and its corresponding label plurality;
generating a weighted average plurality of parameters by combining parameters defining each candidate machine learning model in the first plurality of candidate machine learning models using weights corresponding to the plurality of datasets; and
generating the machine learning model using the weighted average plurality of parameters.

5. The method of claim 2, wherein the second resource processing system comprises a real-time resource processing system, wherein using the second resource processing system to generate the plurality of approval determinations comprises:
comparing a first plurality of deterministic rules against a resource access request, wherein the first plurality of deterministic rules specifies requirements of a user account associated with the resource access request;
comparing a second plurality of deterministic rules against a first account state and a second account state, wherein the first account state and the second account state are associated with the resource access request, and wherein the second plurality of deterministic rules specifies relations between the first account state and the second account state; and
in response to the resource access request satisfying the first plurality of deterministic rules and the first account state and the second account state satisfying the first plurality of deterministic rules, determining to approve the resource access request.

6. The method of claim 2, wherein determining that there is a discrepancy comprises:
computing a mathematical difference between the first confidence score and an encoding vector for the first approval determination, wherein the encoding vector represents an approval decision as one and a denial decision as zero; and
determining that there is a discrepancy based on the mathematical difference.

7. The method of claim 2, wherein adjusting the second resource processing system based on the discrepancy and the runtime explainability vector comprises:
identifying a model factor using the runtime explainability vector, wherein the model factor illustrates a consideration of the machine learning model leading to the discrepancy;
identifying a decision component of the second resource processing system corresponding to the model factor, wherein the decision component is a mathematical operation used in approval determinations made by the second resource processing system; and
using a reinforcement learning regimen, updating the decision component.

8. The method of claim 2, further comprising:
using the discrepancy as a loss function, updating the machine learning model.

9. The method of claim 2, wherein:
the machine learning model is defined by a plurality of parameters comprising a matrix of weights for a multivariate regression algorithm; and
the runtime explainability vector is extracted from the machine learning model using a Shapley Additive Explanation method.

10. The method of claim 2, wherein:
the machine learning model is defined by a plurality of parameters comprising a matrix of weights for a supervised classifier algorithm; and
the runtime explainability vector is extracted from the machine learning model using a Local Interpretable Model-agnostic Explanations method.

11. The method of claim 2, wherein:
the machine learning model is defined by a plurality of parameters comprising a matrix of weights for a convolutional neural network algorithm; and
the runtime explainability vector is extracted from the machine learning model using a Gradient Class Activation Mapping method.

12. The method of claim 2, wherein:
the machine learning model is defined by a plurality of parameters comprising a hyperplane matrix for a support vector machine algorithm; and
the runtime explainability vector is extracted from the machine learning model using a counterfactual explanation method.

13. One or more non-transitory computer-readable media comprising instructions that, when executed by one or more processors, cause operations comprising:
receiving a machine learning model trained using a training dataset comprising a plurality of approval determinations associated with a first resource processing system, wherein each approval determination in the plurality of approval determinations corresponds to one or more resource access requests;
processing, using a second resource processing system, a first resource access request and generating a first approval determination, wherein the second resource processing system determines to approve or decline resource access requests based on a plurality of logical operations;
applying the machine learning model to process the first resource access request and the first approval determination and generate a first confidence score that the first resource access request was executed correctly;
extracting a runtime explainability vector from the processing by the machine learning model;
based on the first confidence score not exceeding a numeric threshold corresponding to the first approval determination, determining that there is a discrepancy between the first approval determination by the second resource processing system and an expected approval determination based on the machine learning model; and
based on the discrepancy and the runtime explainability vector, adjusting the plurality of logical operations of the second resource processing system.

14. The one or more non-transitory computer-readable media of claim 13, wherein:
the training dataset comprises a plurality of datasets, each dataset in which comprises a plurality of sample first account states and a plurality of sample second account states corresponding to an approval determination vector.

15. The one or more non-transitory computer-readable media of claim 14, wherein training the machine learning model comprises:
training a first plurality of candidate machine learning models, each candidate machine learning model trained using an unlabeled batch dataset and its corresponding label plurality;
generating a weighted average plurality of parameters by combining parameters defining each candidate machine learning model in the first plurality of candidate machine learning models using weights corresponding to the plurality of datasets; and
generating the machine learning model using the weighted average plurality of parameters.

16. The one or more non-transitory computer-readable media of claim 15, wherein adjusting the second resource processing system based on the discrepancy and the runtime explainability vector comprises:
identifying a model factor using the runtime explainability vector, wherein the model factor illustrates a consideration of the machine learning model leading to the discrepancy;
identifying a decision component of the second resource processing system corresponding to the model factor, wherein the decision component is a mathematical operation used in approval determinations made by the second resource processing system; and
using a reinforcement learning regimen, updating the decision component.

17. The one or more non-transitory computer-readable media of claim 13, wherein:
the machine learning model is defined by a plurality of parameters comprising a matrix of weights for a multivariate regression algorithm; and
the runtime explainability vector is extracted from the machine learning model using a Shapley Additive Explanation method.

18. The one or more non-transitory computer-readable media of claim 13, wherein:
the machine learning model is defined by a plurality of parameters comprising a matrix of weights for a supervised classifier algorithm; and
the runtime explainability vector is extracted from the machine learning model using a Local Interpretable Model-agnostic Explanations method.

19. The one or more non-transitory computer-readable media of claim 13, wherein:
the machine learning model is defined by a plurality of parameters comprising a matrix of weights for a convolutional neural network algorithm; and
the runtime explainability vector is extracted from the machine learning model using a Gradient Class Activation Mapping method.

20. The one or more non-transitory computer-readable media of claim 13, wherein:
the machine learning model is defined by a plurality of parameters comprising a hyperplane matrix for a support vector machine algorithm; and
the runtime explainability vector is extracted from the machine learning model using a counterfactual explanation method.
